(19) United States
(12) Patent Application Publication
(10) Pub. No.: US 2026/0036983 A1
(43) Pub. Date: Feb. 5, 2026

(54) OPERATION PLANNING METHOD, DEVICE FOR MOVABLE PLATFORM AND STORAGE MEDIUM

(71) Applicant: SZ DJI TECHNOLOGY CO., LTD., Shenzhen (CN)

(72) Inventors: Hengbin FANG, Shenzhen (CN); Chen CHEN, Shenzhen (CN); Zhen ZHOU, Shenzhen (CN)

(73) Assignee: SZ DJI TECHNOLOGY CO., LTD., Shenzhen (CN)

(21) Appl. No.: 19/357,036

(22) Filed: Oct. 13, 2025

Related U.S. Application Data
(63) Continuation of application No. PCT/CN2023/090987, filed on Apr. 26, 2023.

(51) Int. Cl. G05D 1/246; G05D 1/223; G05D 1/648

(52) U.S. Cl. CPC G05D 1/2465; G05D 1/223; G05D 1/648

(57) ABSTRACT

A method and device for operation planning of a movable platform, and a storage medium are provided. The method includes: obtaining a three-dimensional model of an operation area of a movable platform; controlling a motion trajectory of a virtual movable platform in the three-dimensional model based on a detected motion control operation; determining multiple target position points on the motion trajectory based on a detected position confirmation operation, where the multiple target position points are used to generate an operation path of the movable platform in the operation area. By simulating the control of the movable platform in the real world, controlling the motion trajectory of the virtual movable platform in the three-dimensional model of the operation area, and thereby determining target position points, the operation path determined using this method is safer, more reasonable, and has higher accuracy.

### RELATED APPLICATIONS

This application is a continuation application of PCT application No. PCT/CN2023/090987, filed on Apr. 26, 2023, and the content of which is incorporated herein by reference in its entirety.

### TECHNICAL FIELD

Some exemplary embodiments of the present disclosure relate to the technical field of movable platforms, and in particular to an operation planning method and device for a movable platform, and a storage medium.

### BACKGROUND

Movable platform is widely used in many fields, such as inspection through aircraft, ground platforms and other movable platforms, fruit picking, or drug spraying, watering, etc. Before using a movable platform for operation, it is usually necessary to perform operation planning for the movable platform to determine the operation position of the movable platform when operating within the operation area. Reasonable operation planning is a prerequisite for ensuring the safe operation of the movable platform and obtaining good operation results. Therefore, it is necessary to provide a solution for operation planning of the movable platform.

### SUMMARY

In view of the foregoing, the present disclosure provides an operation planning method and device for a movable platform, and a storage medium.

According to a first aspect of the present disclosure, an operation planning method for a movable platform is provided, the method including: obtaining a three-dimensional model of an operation area of a movable platform; controlling a motion trajectory of a virtual movable platform in the three-dimensional model according to a detected motion control operation; and determining a plurality of target position points on the motion trajectory according to a detected position confirmation operation, where the plurality of target position points are used to generate an operation path of the movable platform in the operation area.

According to a second aspect of the present disclosure, an operation planning device for a movable platform is provided, the device includes a processor, a memory, and a computer program stored in the memory and executable by the processor, where when the processor executes the computer program, the following steps can be implemented: obtaining a three-dimensional model of an operation area of a movable platform; controlling a motion trajectory of a virtual movable platform in the three-dimensional model according to a detected motion control operation; and determining a plurality of target position points on the motion trajectory according to a detected position confirmation operation, where the plurality of target position points are used to generate an operation path of the movable platform in the operation area.

Applying the solution provided by the present disclosure, when performing operation planning for a movable platform, similar to controlling a movable platform to move in an operation area in the real world, it is possible to control a virtual movable platform to move continuously in a three-dimensional model of the operation area, and when the virtual movable platform moves to a suitable operating position, a position confirmation operation is triggered, thereby obtaining multiple target position points for generating an operation path of the movable platform in the operation area. By simulating the control of a movable platform in the real world to control the continuous movement of the virtual movable platform in the three-dimensional model of the operation area, the operation path determined in this way will be safer, more reasonable, and more accurate.

It should be understood that the above general description and the following detailed description are exemplary and explanatory only, and are not restrictive of the present disclosure.

### BRIEF DESCRIPTION OF THE DRAWINGS

To illustrate the technical solutions in some exemplary embodiments of the present disclosure, the accompanying drawings that need to be used in the description of some exemplary embodiments will be briefly introduced below. Obviously, the accompanying drawings in the following description are only some exemplary embodiments of the present disclosure, and for those of ordinary skill in the art, other accompanying drawings can also be obtained according to these accompanying drawings without creative effort.

FIG. 1 is a schematic diagram of an application scenario according to some exemplary embodiments of the present disclosure.

FIG. 2 is a flowchart of an operation planning method for a movable platform according to some exemplary embodiments of the present disclosure.

FIG. 3 is a schematic diagram showing the movement of a virtual movable platform in a three-dimensional model of an operation area displayed on an interactive interface according to some exemplary embodiments of the present disclosure.

FIG. 4 is a schematic diagram of adjusting an observed image to obtain a sample image according to some exemplary embodiments of the present disclosure.

FIG. 5 is a schematic diagram of editing target position points according to some exemplary embodiments of the present disclosure.

FIG. 6(a) is a schematic diagram of a three-dimensional model from a third-person view angle according to some exemplary embodiments of the present disclosure.

FIG. 6(b) is a schematic diagram of a three-dimensional model from a map overhead view angle according to some exemplary embodiments of the present disclosure.

FIG. 7 is a schematic diagram showing safety prompt information on an interactive interface according to some exemplary embodiments of the present disclosure.

FIG. 8 is a schematic diagram showing global target position points according to some exemplary embodiments of the present disclosure.

FIG. 9 is a schematic diagram of the logical structure of an operation planning device for a movable platform according to some exemplary embodiments of the present disclosure.

### DETAILED DESCRIPTION

The technical solutions in some exemplary embodiments of the present disclosure will be described below in conjunction with the accompanying drawings in some exemplary embodiments of the present disclosure. Obviously, the described embodiments are merely a part of some exemplary embodiments of the present disclosure, and not all of some exemplary embodiments. Based on some exemplary embodiments in the present disclosure, all other embodiments obtained by a person of ordinary skill in the art without creative effort shall fall within the scope of protection of the present disclosure.

Movable platforms are widely used in many fields, for example, inspection through aircraft, ground platforms, and other movable platforms, fruit picking, or drug spraying, watering, etc. Before using a movable platform for the above operations, it is usually necessary to perform operation planning for the movable platform to determine the various target position points when the movable platform is operating. For example, taking the inspection of power equipment as an example, it is necessary to pre-plan the target positions where the movable platform will take pictures of each power device to ensure that target images containing the power equipment can be captured at these target positions. Furthermore, operation parameters such as the orientation and magnification of the load carried by the movable platform, such as a shooting device, can also be recorded at the target position, so that the target images captured at this target position are more accurate.

In related technologies, when performing operation planning for a movable platform, some technologies involve the user directly going to the operation site to manually control the movable platform. For example, the user manually adjusts the position of the movable platform based on their observation or the operation results returned by the movable platform, and records it when adjusted to a suitable position, so that the movable platform can be controlled to operate according to the planned position points during subsequent operations. This method requires the user to manually operate the movable platform at the operation site, which requires high user control skills, is labor-intensive, has low operation efficiency, and also has safety risks.

To facilitate users in performing operation planning for movable platforms, some technologies also provide software for users to perform operation planning. For example, the operation planning software can display a three-dimensional model of the operation area in an interactive interface, and the position of the movable platform during operation can be determined by the user's operations on the interactive interface displaying the three-dimensional model of the operation area. For example, the user can move or rotate the three-dimensional model of the operation area in the three-dimensional model, and perform a click operation at a position near the work object to determine the target work object, and then infer the position during operation based on relevant work distance and other information. Although this method does not require the user to manually operate the movable platform on-site, it is not intuitive and requires the user to repeatedly adjust to obtain the operating position, which is particularly cumbersome.

However, when using current operation planning software for operation planning, each target position point on the operation path is planned independently, and there is no connection between different target position points. When planning different target position points, it is also impossible to know the passability and safety of the operation path formed by connecting these target position points, such as whether the planning of the operation path is safe and reasonable, whether there are obstacles on the operation path, and whether the operation path can guarantee the operation effect, etc., which may lead to the final planned operation path being not safe enough or reasonable enough.

Based on the foregoing, some exemplary embodiments of the present disclosure provide an operation planning method for a movable platform. When performing operation planning for the movable platform, similar to controlling the movable platform to move in the operation area in the real world, it is possible to control a virtual movable platform to move continuously in a three-dimensional model of the operation area, and when the virtual movable platform moves to a suitable operating position, a position confirmation operation is triggered, thereby obtaining multiple target position points for generating an operation path of the movable platform in the operation area. By simulating the control of the movable platform in the real world to control the continuous movement of the virtual movable platform in the three-dimensional model of the operation area, the operation path determined in this way will be safer, more reasonable, and more accurate.

The operation planning method provided in some exemplary embodiments of the present disclosure can be executed by an APP or a web application running on a terminal. For example, the APP or web application can be a type of operation path planning software; or the method can also be executed by a cloud server or a server cluster; or some processing steps of the method can be executed by a cloud server or a server cluster, and other processing steps can be executed by an APP or a web application on a terminal. The specific implementation can be flexibly set based on actual needs, and some exemplary embodiments of the present disclosure do not impose any limitations in this regard.

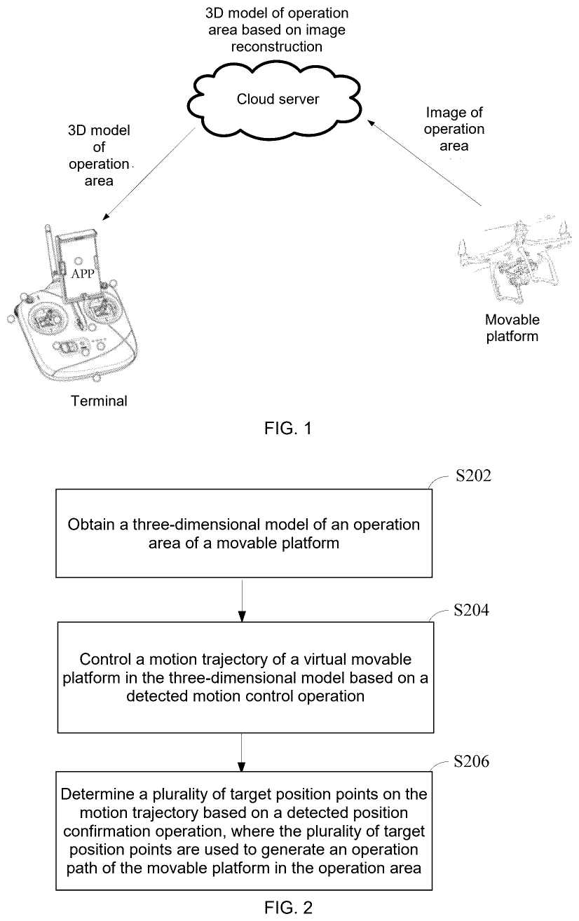

Exemplarily, the executing entity of this method can be any device with sufficient performance to support the acquisition and display of a three-dimensional model. For example, in some scenarios, as shown in FIG. 1, a cloud server can acquire images of the operation area collected by a movable platform (taking an aircraft as an example in the figure), and then pre-construct a three-dimensional model of the movable platform's operation area based on these images. A client on a terminal (which can be an APP or a web application) can obtain this three-dimensional model from the cloud server for operation path planning based on the model. Of course, in some scenarios, if the performance of the terminal is sufficient to realize the construction of the three-dimensional model, both the construction of the three-dimensional model and the planning of the operation path can be implemented on the terminal. The terminal can be a mobile phone, tablet, computer, remote controller, or other device. Taking a computer as an example of the terminal, the construction of the three-dimensional model of the operation area can be realized through computer software or a web page. Furthermore, the three-dimensional model can be displayed through a display screen. In some exemplary embodiments, operation path planning can be implemented based on a mouse, keyboard, etc. Taking a remote controller as an example of the terminal, the construction of the three-dimensional model of the operation area can be realized through an APP in the remote controller. Furthermore, the three-dimensional model can be displayed through the UI interface of the remote controller, and operation path planning can be implemented based on the UI interface and the joystick of the remote controller.

The movable platform in some exemplary embodiments of the present disclosure can be a movable platform used to perform operations on a target object. The movable platform includes a power component for driving the movable platform to move. The movable platform can be an aircraft, a vehicle, a ship, an intelligent robot, or other movable equipment. The movable platform can be manned or unmanned. In some exemplary embodiments, the movable platform includes a load for performing operations, which can be a shooting device, a mechanical arm, a hanging system, a spraying system, etc. Some exemplary embodiments of the present disclosure do not specifically limit the type of load.

In some exemplary embodiments, the aircraft can include a rotorcraft, such as a quadrotor, hexacopter, or octocopter, or it can be a fixed-wing aircraft, or a combination of a rotorcraft and a fixed-wing aircraft. In some exemplary embodiments, the aircraft includes an unmanned aerial vehicle. The aircraft may include, but is not limited to, any one of a manned aircraft, a logistics aircraft, an aerial photography aircraft, an agricultural plant protection aircraft, and an industrial rescue aircraft. The above are merely examples, and some exemplary embodiments of the present disclosure do not specifically limit the type of aircraft.

Any description in this application of aircraft, such as unmanned aerial vehicles, can be applied to and used for any movable object, such as any vehicle. In addition, the methods, devices, and systems disclosed in this application in the context of aerial movement can also be applied to other types of movement scenarios, such as movement on the ground or on water, underwater movement, or movement in space.

Specifically, as shown in FIG. 2, the operation planning method may include the following steps:
S202: Obtain a three-dimensional model of an operation area of a movable platform.

In step S202, a three-dimensional model of the movable platform's operation area can be obtained, which can be by calling an already generated three-dimensional model, or by generating a three-dimensional model in real time based on requirements. There can be various ways to generate this three-dimensional model. Among them, the three-dimensional model of the operation area can be obtained by capturing images of the operation area and then performing three-dimensional reconstruction of the operation area based on the images, or it can be obtained by collecting three-dimensional point clouds of the operation area using lidar and then generating the model based on the three-dimensional point clouds. It is not difficult to understand that any method that can obtain a three-dimensional model of the operation area is applicable in the solutions of some exemplary embodiments of the present disclosure, and some exemplary embodiments of the present disclosure do not impose any limitations in this regard.
S204, Control a motion trajectory of a virtual movable platform in the three-dimensional model based on a detected motion control operation.

In step S204, after obtaining the three-dimensional model of the operation area, the motion control operation on the virtual movable platform can be detected, and then the motion trajectory of the virtual movable platform in the three-dimensional model can be controlled based on the detected motion control operation. The virtual movable platform can be an identifier used to represent the movable platform, for example, the identifier can be a three-dimensional model corresponding to the movable platform, or an image identifier representing the movable platform, or it can be merely a point used to represent the movable platform.

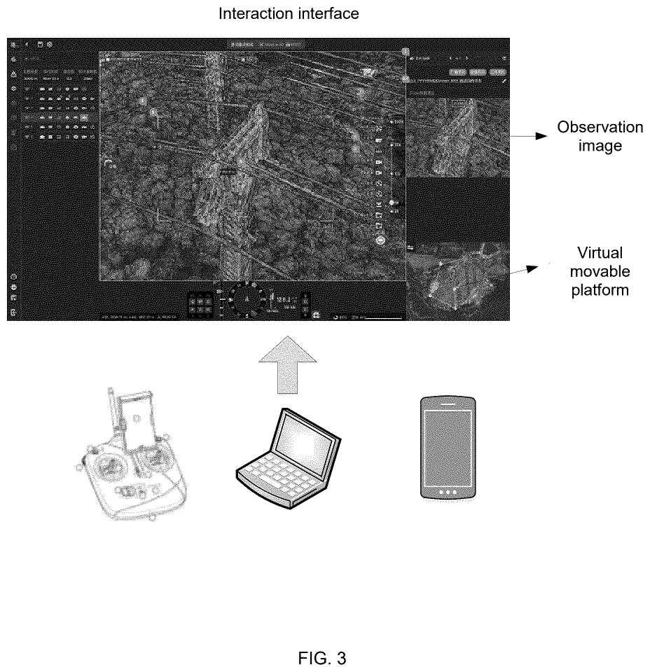

The motion control operation for the movable platform can be input by a user or automatically generated by the device. For example, taking user control of the virtual movable platform's movement in the three-dimensional model as an example, as shown in FIG. 3, after obtaining the three-dimensional model of the operation area, the three-dimensional model can be displayed on a user interaction interface, and the virtual movable platform can also be displayed on the interaction interface. Then, the control method for the movable platform in the real world can be simulated, manipulating the virtual movable platform to move continuously in the three-dimensional model. After detecting the motion control operation input by the user, the device executing this method can control the virtual movable platform to perform corresponding movements in the three-dimensional model.

The device executing this method may include a user interaction portal, through which the user's motion control operation is detected. For example, the device executing this method may be connected to a remote controller, and the user can input motion control operations through the joystick on the remote controller to control the movement of the virtual movable platform. Alternatively, the device executing this method may also be connected to physical control devices such as a keyboard or mouse, and the user can control the movement of the virtual movable platform through these physical control devices. Alternatively, the device executing this method may include a touchscreen, and the user can control the movement of the virtual movable platform through virtual buttons on the touchscreen. Alternatively, the device executing this method may be connected to the user's VR glasses, and the user can control the movement of the virtual movable platform through the VR glasses. It is not difficult to understand that any method that enables interaction between the user and the device executing this method to input motion control instructions is applicable in some exemplary embodiments of this disclosure, which is not limited herein.

Of course, in some scenarios, the motion control operation can also be automatically generated by the device. For example, the device can automatically analyze the surrounding environment or the scene where the virtual movable platform is located, and then control the movement of the virtual movable platform based on the analysis results. This is equivalent to the device automatically simulating human control operations to achieve automatic control of the virtual movable platform.
S206, Determine a plurality of target position points on the motion trajectory based on a detected position confirmation operation, where the plurality of target position points are used to generate an operation path of the movable platform in the operation area.

In step S206, during the process of controlling the virtual movable platform's movement in the three-dimensional model based on the detected motion control operation, the position confirmation operation can be detected in real time. Upon detecting the position confirmation operation, the current position of the virtual movable platform can be designated as a target position point. Then, based on the determined multiple target position points, the operation path of the movable platform in the operation area is generated. The position confirmation operation can be triggered when it is determined that the movable platform is at a position where it can accurately perform operations on the target object. This position confirmation operation can be triggered by the user; for example, if the user determines that the current position is suitable for performing operations on the target object, they can trigger the position confirmation operation. The user can trigger this position confirmation operation through voice, by inputting control commands via control components (such as a keyboard, mouse, joystick, etc.), or by clicking a designated icon on the touchscreen.

Of course, the position confirmation operation can also be automatically triggered by the device. For example, conditions that each target position point must meet can be preset. When the virtual movable platform moves to a certain position, the device can determine in real time whether that position meets the preset conditions. If it does, the position confirmation operation is automatically triggered.

Through the above method, multiple target position points can be determined. Then, based on these multiple target position points, the operation path for the movable platform in the operation area can be generated. The entire planning process is equivalent to simulating the control of the movable platform's movement in the operation area in the real world. By controlling the motion trajectory of the virtual movable platform in the three-dimensional model, the suitability of the selected target position points can be verified at a lower cost. Therefore, determining the operation path in this way is safer, more reasonable, and more accurate.

Moreover, when planning the operation path, the relationships between different target position points can be identified, as well as the passability and safety of the connecting paths between these target position points. For example, it can be determined whether the planning of the operation path is safe and reasonable, whether there are obstacles on the operation path, and whether the operation path can ensure the effectiveness of the operation, achieving a “what you see is what you get” effect in operation planning. That is, the operation path formed by the target position points traversed during the controlled movement of the virtual movable platform in the three-dimensional model corresponds to the operation path of the movable platform in the real environment. Thus, determining the operation path in this way is more reasonable, safe, and accurate.

Furthermore, displaying the observed imagery of the virtual model during the virtual movable platform's movement from the first target position point to the second target position point allows users to conveniently assess the passability and safety of the connecting path between target position points, as well as information about the surrounding environment.

In some exemplary embodiments, the motion control logic for the virtual movable platform can simulate the control logic for the movable platform in the real world. Therefore, the motion control operation may include one or more of lateral control operations, longitudinal control operations, altitude control operations, and yaw control operations for the virtual movable platform. Among these, the lateral control operation, longitudinal control operation, and altitude control operation can respectively control the movement of the virtual movable platform in the left-right, front-back, and up-down directions. The yaw control operation can control the yaw angle of the virtual movable platform. Through these control operations, the control of the virtual movable platform can be made similar to the control of the movable platform in the real world.

In some exemplary embodiments, the motion control operation can be triggered by a control component, and the motion control amount of the motion control operation can be determined based on the detected control speed of the user on the control component (i.e., the change in control amount per unit time) and/or the control amount. The control component can be a physical component such as a mouse, keyboard, or joystick, or a virtual control component on a touchscreen. When controlling a virtual movable platform, the user's control speed on the control component can be mapped to the motion speed of the virtual movable platform. For example, the user's joystick movement speed can be mapped to the motion speed of the virtual movable platform. Additionally, the user's control amount on the control component can be mapped to the motion distance or rotation angle of the virtual movable platform. For instance, the joystick shift amount can be mapped to the motion distance of the virtual movable platform. As another example, if the control component is a keyboard, the control amount of the user's control component can be determined based on the detected pressing time of the keyboard keys, which is then mapped to the motion distance or rotation angle of the virtual movable platform.

In some exemplary embodiments, the motion control operation for the virtual movable platform can be triggered by a joystick, and the motion control amount of the motion control operation can be determined based on the detected shift amount of the joystick. The joystick can be a physical joystick or a virtual joystick.

For example, the physical joystick can be connected to the device executing the method, and the direction of the physical joystick's movement can be mapped to the motion direction of the virtual movable platform, while the shift amount of the physical joystick can be mapped to the motion control amount of the virtual movable platform.

For example, the virtual joystick can be mapped to the change amount of the virtual joystick through the user's control of the keyboard or mouse, and further mapped to the motion control amount of the virtual movable platform. For instance, different keys on the keyboard can be mapped to different movement directions of the virtual joystick, which are then mapped to the motion direction of the virtual movable platform.

Since planning operations for a movable platform involves not only planning the operational positions of the movable platform but also planning the operational parameters for the movable platform at each operational position to ensure precise operations, it is also possible to detect an operation parameter confirmation operation. Based on the detected operation parameter confirmation operation, the operational parameters corresponding to the target position point are determined and stored, where these operational parameters are used to instruct the movable platform to perform operations upon reaching the target position point.

The operation parameter confirmation operation can be triggered by the user or automatically generated by a device. The type of operation parameters varies depending on the load carried by the movable platform and the specific scenario. For example, if the load on the movable platform is a camera and its operation task is to take photos of a target object, the operation parameters may include camera orientation, camera zoom, exposure parameters, etc. If the load is a hoisting system and its operation task is to transport goods, the operation parameters may include the weight of the loaded goods, etc. If the load is a robotic arm and its operation task is to pick fruits or grasp objects, the operation parameters may include grasping distance, grasping angle, etc. If the load is a spraying system and its operation task is to spray chemicals, fertilize, or water, the operation parameters may include spray volume, spraying speed, spraying time, etc. The specific types of operation parameters can be flexibly set based on the actual application scenario.

In some exemplary embodiments, the movable platform may be equipped with a camera/camera load, and the operation parameter can be the orientation parameter of the camera load in space. This orientation parameter is used to instruct the camera load to perform operations according to the specified orientation when the movable platform reaches the target position point. For example, when the movable platform reaches the target position point, the camera can adjust its orientation to the direction indicated by the orientation parameter and then perform the photography task.

In some exemplary embodiments, the camera can be mounted on a gimbal, and the gimbal can be controlled to rotate based on the operation parameter to adjust the camera load to the orientation indicated by the operation parameter.

In some exemplary embodiments, the orientation of the camera load mounted on the movable platform is adjusted to determine precise operation parameters. During the process of controlling the motion of the virtual movable platform, an orientation control operation for controlling the orientation of the virtual observation device on the virtual movable platform can be detected. The orientation of the virtual observation device is then controlled based on the detected orientation control operation. After detecting an orientation confirmation operation, the target orientation of the virtual observation device can be determined for each target position point on the motion trajectory of the virtual movable platform. When the movable platform moves to each target position point, the camera load mounted on the movable platform can be controlled to operate according to the target orientation. The orientation control operation and the orientation confirmation operation can be triggered by the user or automatically generated by the device.

In some exemplary embodiments, the position confirmation operation and the operation parameter confirmation operation can be determined based on the same user-triggered operation. For example, when a user-triggered confirmation operation is detected, the current position of the virtual movable platform and the current operation parameters are recorded simultaneously. In some exemplary embodiments, the position confirmation operation and the operation parameter confirmation operation can also be different operations triggered by the user. For example, the user can first trigger one confirmation operation to determine the target position point and then trigger another confirmation operation to determine the operation parameters corresponding to that target position point. Alternatively, the user can first trigger one confirmation operation to determine the operation parameters corresponding to the target position point, and then another confirmation operation is automatically triggered to determine the target position point corresponding to those operation parameters.

In some exemplary embodiments, after determining the target position point, an operation result corresponding to the target position point can be further determined, and the target position point and/or the operation parameters corresponding to the target position point can be adjusted based on the operation result. The operation result can be used to indicate the deviation between the actual operation completion status and the ideal situation when the movable platform performs operations at the target position point. The adjusted target position point is used to regenerate the operation path of the movable platform in the operation area, and the adjusted operation parameters are used to instruct the load of the movable platform to perform operations at the adjusted target position point. By automatically adjusting the operation path and operation parameters based on the deviation between the actual operation completion status and the ideal situation when the movable platform performs operations at the target position point, the final determined operation parameters and operation path can be made more accurate.

In some exemplary embodiments, as shown in FIG. 3, during the process of controlling the virtual movable platform's movement in a three-dimensional model, the observation view angle of the virtual observation device mounted on the virtual movable platform can be determined based on the attitude of the virtual movable platform during its movement. The three-dimensional model is projected onto this observation view angle to obtain an observation image, which is displayed in real-time on the user interaction interface. For example, during the process of controlling the virtual movable platform's movement in the three-dimensional model, the interaction interface can display in real-time the observation images of the three-dimensional model from the view angle of the virtual movable platform or the virtual load mounted on it. This allows the user to understand the operational status of the movable platform at its current position, such as the content captured by the camera mounted on the movable platform, whether the robotic arm mounted on the movable platform can pick fruits, or whether the spraying device mounted on the movable platform can be aimed at the crops to be sprayed, and so on.

In some exemplary embodiments, the load mounted on the movable platform can be a camera. During the process of controlling the virtual movable platform's movement in a three-dimensional model, the orientation information of the virtual camera on the virtual movable platform in space can be obtained. Based on this orientation information, the observation image of the virtual camera on the scenes in the three-dimensional model is determined and displayed. This allows the user to know whether the captured image includes the desired target object when the movable platform is at the current position and the camera takes photos according to the orientation information.

In some exemplary embodiments, the load on the movable platform is a photographing device, and its operation task is to take photos of a target object. The operation result can be the deviation between the images captured by the photographing device when the movable platform is at each target position point and a reference image. The reference image can be an image determined based on the user's adjustment operation on the observation image. For example, when the user finds, based on the observation image, that the current position of the virtual movable platform is not the optimal position for the movable platform to perform operations on the target object, the user can adjust the observation image. This allows the virtual movable platform to achieve more accurate operation results when it is at a position where the adjusted observation image can be observed. Adjusting the observation image can involve adjusting part or all of the pixel areas of the observation image, and this adjustment operation can include modifying the imaging position and size of the content corresponding to the adjusted pixel area in the observation image.

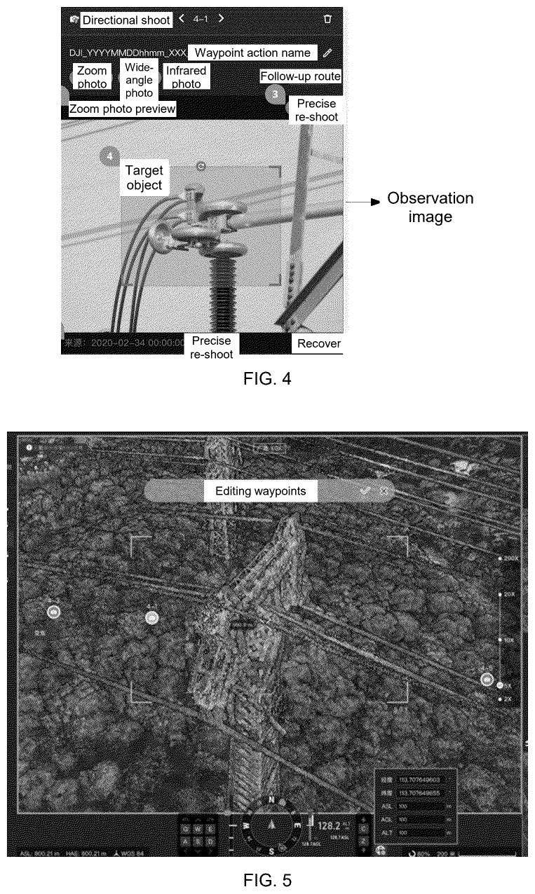

For example, the load mounted on the movable platform is a camera, and its operation task is to capture images of a target object in the operation area. When controlling the virtual movable platform's movement in a three-dimensional model, the interaction interface can display in real-time the observation image of the three-dimensional model captured by the virtual camera on the virtual movable platform (i.e., the image that the virtual camera can capture, which is also the image captured by the camera on the movable platform in the actual operation scenario). Based on this observation image, it is possible to determine the content of the image captured by the movable platform in the actual operation scenario when it is at that position, such as whether it can capture the complete target object, whether the target object is located at the center of the image, and so on. As shown in FIG. 4, if the target object in the observation image is too small or not located at the center of the image, the observation image can be adjusted. For instance, the target object can be re-framed in the observation image, or the observation image can be moved to place the target object at the center of the image, or the image can be zoomed in to increase the proportion of the target object in the image. The adjusted observation image becomes the reference image, and the device executing this method can readjust the target position point and/or operation parameters based on the deviation between the observation image and the reference image. For example, the position of the target position point can be adjusted based on the positional difference of the target object in the image, or the camera's zoom level can be adjusted based on the difference in the proportion of the target object in the image, and so on.

In addition, after detecting an adjustment operation on the observation image, to facilitate understanding the content of the adjusted reference image, the reference image can be displayed on the interaction interface, for example, by presenting the adjusted reference image as the new observation image on the interaction interface. For instance, when the user reviews the new observation image and determines that it meets the requirements, they can trigger a position confirmation operation or an operation parameter confirmation operation.

By adjusting the observation image, the operation path and operation parameters of the movable platform during operations can be automatically adjusted, achieving a “what you see is what you get” effect. This means that the displayed observation image is the image captured by the movable platform during operations, making the operation planning for the movable platform more intuitive.

In some exemplary embodiments, when controlling the motion trajectory of the virtual movable platform in a three-dimensional model based on the detected motion control operation, the virtual movable platform can be controlled to depart from a first position in the three-dimensional model and move toward other areas in the three-dimensional model according to the detected motion control operation. Then, based on the detected position confirmation operation, the current position of the virtual movable platform in the three-dimensional model is determined as a second position. The first position and the second position are used to generate the operation path of the movable platform in the operation area.

In some exemplary embodiments, to facilitate users in adjusting the planned operation path, an editing function for target location points can be provided. Upon detecting a user's editing operation, one or more of the following operations can be performed: deleting a determined target location point, adjusting the position of a determined target location point, inserting a new target location point between any two adjacent target location points, or modifying the operation parameters corresponding to a target location point. As shown in FIG. 5, taking the route determination of an unmanned aerial vehicle (UAV) as an example, the user can click on a determined waypoint and then edit that waypoint, for instance, editing the waypoint's position, operation task, or operation parameters. In this way, users can adjust the determined target location points at any time during the operation planning process, making it more convenient and efficient.

In some exemplary embodiments, when the virtual movable platform moves to a determined target location point, the interactive interface can display information corresponding to that target location point, such as the observation image of the three-dimensional model by the movable platform at that target location point, the operation parameters corresponding to the target location point, the distance information between the movable platform and surrounding environmental objects when located at that target location point, and so on. Therefore, when reviewing information related to previously determined target location points, the virtual movable platform can be moved to the corresponding target location point. The device executing this method, upon detecting a movement operation, can move the virtual movable platform from its current position to any determined target location point and display the relevant information of that target location point on the interactive interface.

In some exemplary embodiments, to facilitate users in understanding the current orientation of the virtual observation device mounted on the virtual movable platform, an identifier representing the orientation of the virtual observation device can be displayed on the interactive interface. The display of the identifier for the orientation of the virtual observation device on the interactive interface can be shown in real-time during the process of controlling the virtual movable platform's movement in the three-dimensional model, or it can be shown when the virtual movable platform is located at a target location point.

In some exemplary embodiments, after determining a target location point, to facilitate understanding the surrounding environmental information of the current location point, the scenery in the three-dimensional model around the target location point can be displayed on the interactive interface, so as to clearly perceive the real operating environment of the movable platform.

In some exemplary embodiments, after obtaining the three-dimensional model of the operation area, the three-dimensional model can be displayed on the interactive interface. To facilitate displaying the information of the three-dimensional model from different angles, the display view angle of the three-dimensional model on the interactive interface can include multiple options, and the display view angle of the three-dimensional model can be switched based on actual needs. For example, upon detecting a view angle-switching operation input by the user, the display view angle of the three-dimensional model on the interactive interface can be switched to the view angle indicated by the view angle-switching operation.

In some exemplary embodiments, the view angle positions of any two view angles among the multiple view angles are different, and/or the directions from the view angle positions of any two view angles toward the virtual movable platform are different. For instance, these multiple view angles can include the first-person view angle of the movable platform, a top-down map view angle, a second-person view angle, and a third-person view angle.

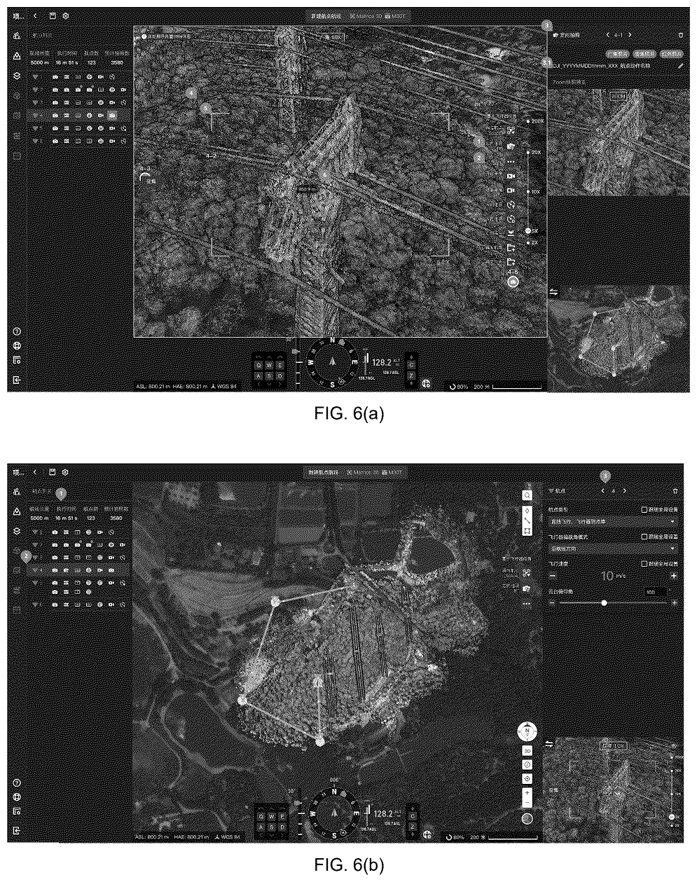

In the first-person view angle of the movable platform, the observation image obtained by the movable platform observing the three-dimensional model can be displayed full-screen on the interactive interface. This view angle allows users to clearly see the observation image corresponding to the target location, as shown in FIG. 6(a), which is an image of the three-dimensional model displayed in the first-person view angle.

In the top-down map view angle, the overall information of each target location point in the entire operation path can be displayed, making it convenient for users to determine whether any target location points are missing and to view the information of each target location point in the horizontal direction, as shown in FIG. 6(b), which is an image of the three-dimensional model displayed in the top-down map view angle.

In the second-person view angle, it is convenient for users to understand the environmental information of the movable platform in the vertical direction.

In cases where the terrain has significant undulations and there are many surrounding obstacles, users can switch to the third-person view angle. In the third-person view angle, users can clearly see the obstacle information around the movable platform.

In summary, the information displayed varies across different view angles, and users can switch to the corresponding view angle based on actual needs to obtain information from different dimensions.

In some exemplary embodiments, the position of the view angle in any view angle changes with the movement of the virtual movable platform, and the relative position between the view angle and the virtual movable platform remains fixed, thereby ensuring that environmental information around the motion trajectory of the movable platform can be accurately obtained in real-time during its movement.

Related operation planning schemes that use the first-person view angle to determine operation parameters do not support the movable platform performing operations while moving, nor do they support directly determining operation parameters other than photography in the current view angle. The solution in this disclosure allows users to freely determine target location points directly in multiple view angles, including the first-person view angle, the top-down map view angle, the third-person follow view angle trailing the movable platform, and the fixed-angle third-person view angle, and enables quick adjustment of all relevant parameters associated with the target location points.

In some exemplary embodiments, when displaying the three-dimensional model of the operation area and the virtual movable platform on the interactive interface, to present the position information of the virtual movable platform in the three-dimensional model from different angles, the screen displayed on the interactive interface can include one or more of the following: a screen showing the three-dimensional model observed by the virtual movable platform, or a screen showing the relative positional relationship between the virtual movable platform and the three-dimensional model. The former helps users understand the scenery in the three-dimensional model observed by the virtual movable platform at its current position, while the latter helps users understand the environmental information around the virtual movable platform at its current position.

In some exemplary embodiments, to enable perception of the environmental information around the movable platform when it is at any target location during the operation planning process, such as whether there are obstacles nearby, potential safety hazards, or whether the operation path is reasonable, safety prompt information can be displayed on the interactive interface after determining the target location. The safety prompt information can be determined based on one or more of the following: the relative positional relationship between the target location points on the motion trajectory of the virtual movable platform and the envelope points of the three-dimensional model, or the variation in the motion posture of the virtual movable platform along the motion trajectory. The envelope points can be used to represent the position of a specific object in the three-dimensional model, such as a position point corresponding to a tree in the three-dimensional model or a position point corresponding to the ground.

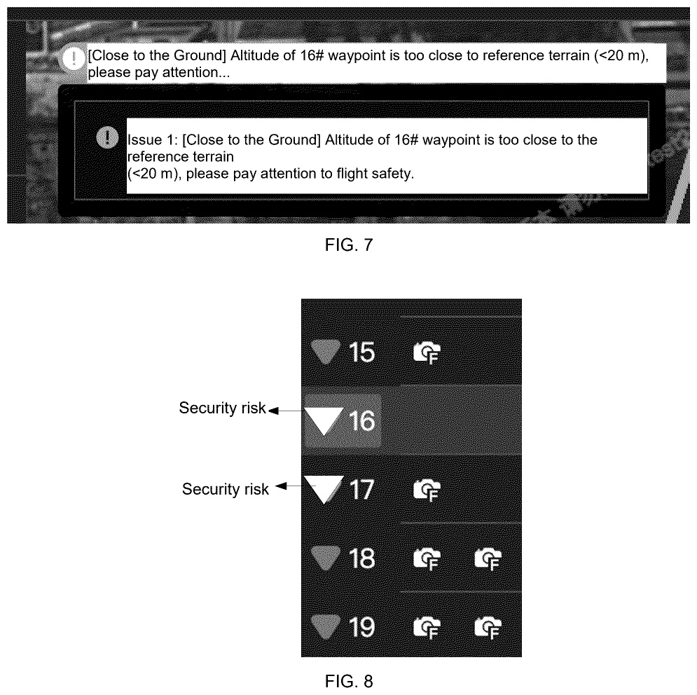

In some exemplary embodiments, the relative positional relationship between the target location points on the motion trajectory and the envelope points of the three-dimensional model can be the distance between the target location points and obstacles and/or the height of the target location points relative to the ground. By determining the proximity of the target location points to obstacles, their relative height to the ground, and other factors, it is possible to assess whether there are safety risks during the movement of the virtual movable platform, such as whether the distance to obstacles is too close or the height above the ground is too low. If a safety risk is identified, safety prompt information can be generated and displayed on the interactive interface to alert the user to potential risks, as shown in FIG. 7, which is a schematic diagram of displaying safety prompt information on the interactive interface.

Of course, during the movement of the movable platform, it is not only necessary to consider the distance to obstacles to avoid collisions but also to ensure that the motion trajectory of the movable platform is smooth, avoiding situations such as sharp turns. Therefore, the motion attitude change of the virtual movable platform along the motion trajectory can also be determined. The motion attitude change can be the change in the motion attitude of the virtual movable platform per unit of time or per unit of distance. If the motion attitude change is excessively large, safety prompt information can be displayed on the interactive interface to alert the user.

Since the three-dimensional model contains accurate environmental data, relevant obstacles can be displayed on the interactive interface in a timely and accurate manner. In some exemplary embodiments, the main window of the interactive interface can display the distance between the current virtual movable platform and surrounding obstacles, as well as the attitude information of the current virtual movable platform. In some exemplary embodiments, on the interactive interface, users can quickly view the distance to obstacles around the current virtual movable platform or review the obstacle status at any target location point. In some exemplary embodiments, for operation planning in complex environments, the relationship between target location points and obstacles can also be displayed by leveraging the advantage of actual physical information existing in the virtual space of the three-dimensional model, facilitating a global overview of target operation points and/or the operation parameters of target operation points after completing the operation planning.

In some exemplary embodiments, to facilitate an intuitive understanding of the current virtual movable platform's height/altitude above the ground, the safety prompt information can include an auxiliary line indicating the relative height of the virtual movable platform above the ground at the target location point, with the height value identified near the auxiliary line. Alternatively, the safety prompt information can directly display an icon that shows the value of the virtual movable platform's relative height above the ground at the target location point.

In some exemplary embodiments, in addition to displaying safety prompt information on the interactive interface, the safety prompt information can also be announced through voice prompts.

In some exemplary embodiments, safety prompt information can be issued in real-time during the process of controlling the virtual movable platform's movement in the three-dimensional model, thereby facilitating the determination of target location points based on the safety prompts. Alternatively, the prompt can be issued after the user or device triggers a position confirmation operation to determine the target location point, in which case the target location point can be adjusted based on the safety prompt information.

In some exemplary embodiments, as shown in FIG. 8, after the user completes the confirmation of each target location point, all target location points of the operation path can be displayed on the interactive interface, with target location points that have safety risks marked, so that the user can identify which target location points in the operation path pose safety risks.

In some exemplary embodiments, the task to be performed by the movable platform is to conduct inspection photography of target objects in the operation area. In such repetitive inspection photography scenarios, due to insufficient control precision of the movable platform's attitude (e.g., insufficient control precision of the gimbal), there may be significant deviations between the captured image and the expected image when re-shooting at a certain target location point, particularly in long-distance zoom photography scenarios. To avoid the above issue, in repetitive inspection photography scenarios, a precise re-shooting method can be adopted to ensure accurate photography. Precise re-shooting involves pre-storing sample images of the target objects to be photographed by the movable platform at each target location point. When the movable platform performs the photography task at the target location point, it can adjust its attitude based on whether the content of the captured image matches the sample image, thereby ensuring that the captured image includes the target object.

In some exemplary embodiments, to obtain sample images to guide the movable platform in capturing images of target objects during repetitive inspection tasks, after completing the planning of the operation path, the movable platform can be controlled to operate within the operation area according to the planned operation path. The real-scene images captured by the movable platform during this operation are collected and displayed to the user. Then, the image area selected by the user from the real-scene images is extracted as the sample image containing the target object. This sample image is used to instruct the movable platform to capture real-scene images containing the target object in subsequent operations.

For example, assuming the target object to be photographed is electrical equipment, after completing the planning of the operation path for the movable platform and determining the operation parameters at each target location point, the movable platform can be controlled to operate according to the planned operation path and operation parameters, capturing real-scene images. These images are then displayed to the user, who can select the target object by framing a region in the real-scene images. The framed image region selected by the user can then be stored as a sample image to guide the movable platform in capturing images that include the target object during subsequent inspection tasks.

In some exemplary embodiments, considering that a three-dimensional model of the operation area is needed for operation planning, and the three-dimensional model is obtained by performing three-dimensional reconstruction of the scenes in the operation area, serving as a true representation of the operation area, it is also possible to directly obtain a sample image containing the target object based on the three-dimensional model. For example, the three-dimensional model can be observed to obtain an image containing the target object, and this image can be directly used as the sample image. As another example, in some scenarios, the three-dimensional model is obtained by performing three-dimensional reconstruction of images captured of the operation area. Therefore, it is also possible to select an image with a suitable shooting angle that contains the target object from the images used for three-dimensional reconstruction and use this image as the sample image. In summary, by determining the sample image based on the three-dimensional model, there is no need to control the movable platform to actually perform an operation task to obtain the sample image, making it more convenient and faster, greatly improving the operational efficiency of the movable platform.

In some exemplary embodiments, the cloud can adopt this method to achieve a closed-loop operation planning without human presence, freeing up manpower. In some exemplary embodiments, through the aggregation of functions such as communication interaction, precise re-shooting, cloud-based post-reconstruction, and collision detection in the virtual space where the three-dimensional model resides, the safety and operational efficiency of the movable platform's operation planning can be improved. In some exemplary embodiments, the movable platform can be an unmanned aerial vehicle (UAV). In some exemplary embodiments, the operation planning can be the flight path planning of the UAV.

In some exemplary embodiments, the determining of the sample image based on the observation image includes any of the following methods: using the observation image as the sample image; or using the image region at the center of the observation image as the sample image; or using the image region selected by the user from the observation image as the sample image.

In some exemplary embodiments, when observing the three-dimensional model to obtain a sample image containing the target object, the user can perform operations such as rotating or dragging the three-dimensional model to find a view angle from which the target object can be observed. Then, the device executing this method can automatically use the image containing the target object observed by the user from that view angle as the sample image.

In some exemplary embodiments, during the motion of a virtual movable platform, the image containing the target object obtained by observing the three-dimensional model with the virtual movable platform can be used as the sample image. For example, during the motion of the virtual movable platform, the observation view angle of the virtual observation device mounted on the virtual movable platform can be determined based on the attitude of the virtual movable platform. Then, the observation image obtained by projecting the three-dimensional model onto this observation view angle can be acquired, and the sample image can be determined based on this observation image.

In some exemplary embodiments, considering that the determined target position point is the location from which the target object can be observed, upon detecting an input position confirmation operation, the observation image obtained by the virtual movable platform observing the three-dimensional model at its current position can be directly used as the sample image containing the target object.

In some exemplary embodiments, the size of the sample image can be preset, meaning the sample image is of a fixed size. Therefore, after obtaining the observation image from the virtual movable platform's observation of the three-dimensional model, the image region at the center of the observation image can be cropped based on the specified size of the sample image to be used as the sample image.

In some exemplary embodiments, to obtain a more accurate and effective sample image, the region containing the target object can be directly selected from the observation image displayed on the interactive interface as the sample image. For example, the target object can be framed within the observation image, and the device executing this method can store the framed image region as the sample image.

For example, during the process of a user controlling a virtual movable platform to move within a three-dimensional model, the observation image of the three-dimensional model by the virtual movable platform can be displayed in real-time on the interactive interface. If the user confirms that the observation image includes the target object to be captured and the target object is located at the center of the image, a position confirmation operation can be triggered. At this point, the device executing this method can designate the current position of the virtual movable platform as the target position point and use the observation image displayed on the interactive interface as the sample image, or crop the image region at the center of the observation image as the sample image. Of course, if the user confirms that the target object is not at the center of the observation image or occupies a small portion of the image, they can first frame the target object within the observation image. The device executing this method can then display the framed image on the interactive interface and automatically adjust the position of the target position point based on the user's framing operation. If the user finds that the image meets their requirements at this point, they can trigger a position confirmation operation to store the adjusted target position point and use the adjusted observation image as the sample image.

The method of determining the sample image through real-world images and the method of directly obtaining the sample image based on a three-dimensional model each have their own advantages. In practical applications, either method can be flexibly chosen based on actual needs. For example, in scenarios where the constructed three-dimensional model has low precision and the target object to be captured is relatively small, obtaining the sample image directly from the three-dimensional model may result in a sample image with low clarity, making it less suitable for guiding the movable platform to capture real-world images with the same content as the sample image during operations. In such cases, the sample image can be obtained by capturing real-world images. Conversely, in scenarios where the precision of the three-dimensional model is sufficient to produce clear images of the target object, the sample image can be directly obtained from the three-dimensional model. This approach eliminates the need to control the movable platform for actual operations, making it convenient and efficient. It also avoids issues where the target object in real-world images may lack clarity due to factors like weather, which could result in an unclear sample image.

In some exemplary embodiments, the method of determining the sample image through real-world images and the method of directly obtaining the sample image based on a three-dimensional model can be combined to complement each other. For example, for parts of the three-dimensional model that are not updated in a timely manner, real-world images can be used to determine the sample image. For parts of real-world images that are obstructed due to weather or external environmental factors, the sample image can be determined based on the three-dimensional model to ensure the accuracy of the sample image.

In addition, in scenarios where the sample image is directly obtained from a three-dimensional model, to ensure the precision and clarity of the sample image, the precision of the three-dimensional model can be adjusted based on the size of the target object to be captured during the model's construction. For example, in scenarios where the target object is small, the precision of the reconstructed three-dimensional model can be higher, while in scenarios where the target object is larger, the precision of the reconstructed three-dimensional model can be lower.

In some exemplary embodiments, real-world images collected by the movable platform during operations along the planned operation path can also be used to update the three-dimensional model of the operation area. For example, if the real-world image collected at a target position point significantly differs from the observation image on the three-dimensional model corresponding to that target position point, an update operation for the three-dimensional model can be triggered using the real-world image. This update operation can be either a global update or a local update.

In some exemplary embodiments, the target position point is displayed on the interactive interface; based on the operation results corresponding to the target position point, the display effect of the target position point on the interactive interface is adjusted. Based on the actual operation results of the movable platform, the target position point can be marked to facilitate the user in understanding the task execution effect of the movable platform at the target position point and/or the fault analysis results of the movable platform's operation objectives. In some exemplary embodiments, the display of the target position point on the interface can be presented in the form of a list or marked at the corresponding virtual space position point in the three-dimensional model.

In some exemplary embodiments, after using the movable platform for inspection and capturing real-world images of the target object, the real-world images collected from the current inspection task can be compared with those collected from historical inspection tasks for similarity matching to determine their similarity. For example, for a specific target position point on the operation path, the similarity between the image captured by the movable platform in a certain attitude during the current inspection task and the image captured by the movable platform in the same attitude during the previous inspection task can be determined. If the similarity is too low, for instance, below a preset threshold, it may indicate that the movable platform's current inspection task has failed, or it could be that the target object to be inspected is obstructed or has malfunctioned. In such cases, a prompt can be sent to the user to help them identify the issue.

In some exemplary embodiments, considering scenarios where the target object to be inspected has minor faults, relying solely on the overall similarity of real-world images collected from each inspection task may not be sufficient to detect such faults. For example, in the case of bridge inspection, if a crack appears on the bridge, similarity matching between real-world images collected from two inspection tasks may still show a high similarity, and thus, no prompt would be issued to the user, leading to the user's inability to detect such faults. To address this issue, in scenarios where the similarity between real-world images collected from the current inspection task and those from historical inspection tasks exceeds a preset threshold, further semantic recognition can be performed on the real-world images to identify the target object in each image. Then, the target objects can be compared to determine whether they are similar across the real-world images. If the similarity is low, it may indicate a potential fault in the target object, prompting the issuance of a notification. In some exemplary embodiments, by further integrating semantic recognition, more precise fault analysis of the target object can be achieved. In some exemplary embodiments, by identifying the semantic content represented by each pixel in the current real-world image, historically collected images can serve as a dataset for semantic recognition. This allows analysis of semantic information in the real-world images, such as trees, towers, cracks, or snow, enabling automatic fault analysis.

In some exemplary embodiments, to facilitate subsequent problem localization by the user, information such as the target position point, operation parameters, and inspection task round corresponding to problematic real-world images (e.g., images with overall similarity to historical real-world images that is too low, or images where the target object has too low similarity with the target object in historical real-world images) can be recorded. This aids the user in later identifying the issue. For example, the operation path can be displayed on the interactive interface, with the problematic target position point marked to make it easier to identify which position point on the operation path is experiencing the issue.

In some exemplary embodiments, the results of multiple actual operations of the movable platform are uploaded to the cloud, where the cloud or terminal device can, based on existing operation results and/or user-defined targets, use image matching to alert the user to potential risks in each operation. In some exemplary embodiments, the operations may include fields such as the energy industry, surveying and mapping, and public safety. For example, in the case of power grid inspection, the system may alert the user to damaged or missing electrical components. As another example, in the case of oil and gas inspection, the system may alert the user to a ruptured pipeline. As a further example, in the case of AEC (architecture, engineering, and construction) inspection, the system may alert the user to illegal parking or unauthorized construction in a building project or project cluster. In some exemplary embodiments, the three-dimensional model can be generated based on images of the operation area collected by the movable platform. The movable platform can be controlled to move within the operation area to capture images of the operation area, and then three-dimensional reconstruction of the operation area can be performed based on these images to obtain the three-dimensional model.

For example, taking the operation task of the movable platform as inspecting a target object within the operation area, the cloud can remotely issue commands through a base station to the movable platform within its coverage area, controlling the movable platform to move to the corresponding operation area and capture images of that area. The captured images are then sent back to the cloud, which can use these images to reconstruct a three-dimensional model of the operation area. Alternatively, the cloud can send the images to a terminal device equipped with modeling software and operation planning software. The modeling software is used to complete the modeling of the operation area, and the operation planning software is used to plan the operation path.

In some exemplary embodiments, after determining multiple target position points based on the movement of the virtual movable platform in the three-dimensional model, the multiple target position points may be connected to obtain the operation path of the movable platform in the operation area. Wherein, when connecting the multiple target position points, the multiple target position points may be connected in sequence according to the confirmation order of the target position points to obtain the operation path.

In some exemplary embodiments, considering that the confirmation order of the target position points is not necessarily the optimal operation order, the sequence of the target position points when connecting the multiple target position points to generate the operation path may be different from the order in which the multiple target position points are confirmed. In this case, the multiple target position points may be sorted based on the optimal operation order, and then the multiple target position points may be connected based on the sorting of the target position points to obtain the operation path.

In some exemplary embodiments, when determining the sorting of the target position points, it may be determined according to the movement distance or movement duration required by the movable platform when moving from the starting target position point to the ending target position point along the trajectory line. That is, when determining the sorting of the multiple target position points to obtain the operation path, in some exemplary embodiments, it is to ensure that the movement distance or the movement duration of the movable platform when moving along the operation path is as short as possible, so as to save energy consumption or improve operation efficiency.

In some exemplary embodiments, multiple operation tasks of the virtual movable platform at the target position point may be determined based on the triggered operation task confirmation operation, where the sequence in which the movable platform executes the multiple operation tasks may be the same as the confirmation order of the multiple operation tasks.

In some exemplary embodiments, considering that the confirmation order of the multiple operation tasks is not necessarily the optimal task execution order, after determining the multiple operation tasks, the target sequence for the movable platform to execute the multiple operation tasks at the target position point may be determined based on related information of the multiple operation tasks (for example, the content of the tasks, the attitude of the movable platform when executing the tasks, etc.), so that the movable platform executes the multiple operation tasks at the target position point according to the target sequence, where the target operation sequence is different from the determination order of the multiple operation tasks.

For example, for a certain target position point, the movable platform needs to perform multiple operations at the target position point with multiple different attitudes. Considering that the order in which these multiple operation tasks are confirmed is not necessarily the optimal task execution order, the execution order of the operation tasks may be optimized based on the operation attitude of each operation task to obtain the optimal operation task execution order. For example, the total attitude change of the movable platform during the execution of the multiple operation tasks may be minimized, or the attitude change may be made to progress continuously and gradually, thereby improving the operation efficiency of the movable platform.

In some exemplary embodiments, a method for operation planning of a movable platform is provided, the method including: obtaining a three-dimensional model of an operation area of a movable platform; controlling a virtual movable platform to move along a motion trajectory in the three-dimensional model according to a detected motion control operation; determining multiple target position points on the motion trajectory according to a detected position confirmation operation, where the multiple target position points are used to generate an operation path of the movable platform in the operation area. In some exemplary embodiments, the three-dimensional model is generated based on images of the operation area collected by controlling the movable platform. In some exemplary embodiments, the method further includes: determining an observation view angle of a virtual observation device mounted on the virtual movable platform based on the attitude of the virtual movable platform during movement, and projecting the three-dimensional model to the observation view angle to obtain an observation image, which is displayed in real time on an interactive interface. In some exemplary embodiments, the interactive interface displays a view of the three-dimensional model observed by the virtual movable platform and/or a view showing the relative positional relationship between the virtual movable platform and the three-dimensional model. In some exemplary embodiments, the method further includes determining and storing operation parameters corresponding to the target position points according to a detected operation parameter confirmation operation, where the operation parameters are used to indicate operations to be performed by the movable platform upon reaching the target position points. In some exemplary embodiments, the movable platform is equipped with a camera load, and the operation parameters include orientation parameters of the camera load in space, which are used to indicate that the camera load performs operations according to the orientation parameters when the movable platform reaches the target position points. In some exemplary embodiments, the method further includes: acquiring real scene images collected by the movable platform during operation in the operation area according to the operation path; extracting an image region selected by a user from the real scene images as a sample image containing a target object, where the sample image is used to indicate that the movable platform captures real scene images containing the target object in subsequent operations. In some exemplary embodiments, the method further includes determining a deviation between the real scene image corresponding to the target position point and the sample image, and adjusting the target position point and/or the operation parameters corresponding to the target position point based on the operation result.

In addition, some exemplary embodiments of the present disclosure provide a operation planning method for a movable platform, the method including: obtaining a three-dimensional model of an operation area of a movable platform;
controlling a virtual observation device to move in a virtual space where the three-dimensional model is located according to a motion control operation, and displaying in real time an observation image of the three-dimensional model by a virtual observation device during movement on a user interaction interface;
in response to a user confirmation operation, determining a target geographic attitude corresponding to an attitude of the virtual observation device in the virtual space, where the target geographic attitude is used to indicate an operation of the movable platform in the operation area.

The specific details for implementing the above operation planning method can be referred to in the descriptions of the above embodiments and will not be repeated herein.

Moreover, some exemplary embodiments of the present disclosure provide a operation planning method for a movable platform, the method including:
obtaining an operation path planned in a three-dimensional model of an operation area, and operation parameters of path points on an operation path, where the operation path is generated based on a movement attitude of a virtual movable platform in the three-dimensional model and an observation image of the three-dimensional model by the virtual movable platform;
controlling the movable platform to move along the operation path in the operation area and perform an operation based on the operation parameters of the path points to obtain operation content;
obtaining an operation result obtained by analyzing the operation content;
adjusting the operation path and the operation parameters of the path points on the operation path based on the operation result;
controlling the movable platform to operate in the operation area based on an adjusted operation path and adjusted operation parameters.

The specific details for implementing the above operation planning method can be referred to in the descriptions of the above embodiments and will not be repeated herein.

In addition, some exemplary embodiments of the present disclosure further provide an operation planning system, including a cloud end, a client end, and a movable platform;
the movable platform is configured to collect images of the operation area and send them to the cloud end;
the cloud end is configured to generate a three-dimensional model of the operation area based on the images and send it to the client end;
the client end is configured to display the three-dimensional model on an interactive interface and control a virtual movable platform to move in the three-dimensional model according to a user-input motion control operation, and to display in real time on the user interactive interface the observation image of the three-dimensional model by the virtual movable platform during the movement; in response to a user confirmation operation, a target geographic attitude corresponding to the current attitude of the virtual movable platform is determined, where the target geographic attitude is used to indicate the operation of the movable platform in the operation area.

The detailed implementation of the operation planning system mentioned above can refer to the descriptions in the above embodiments, which will not be repeated herein.

It is not difficult to understand that the schemes described in the above embodiments can be combined when there are no conflicts. Not all combinations are enumerated herein.

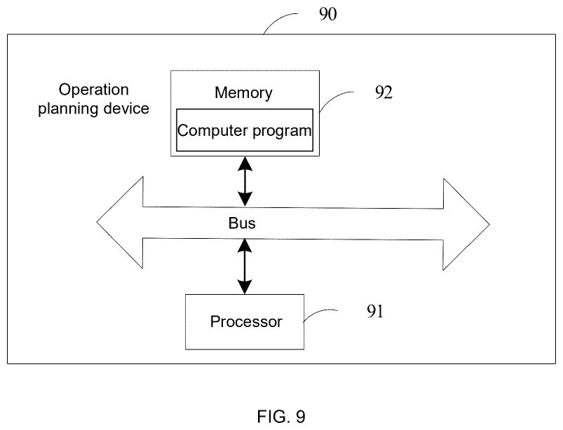

In addition, some exemplary embodiments of this disclosure also provide an operation planning device for a movable platform, as shown in FIG. 9. The device includes a processor 91, a memory 92, and a computer program stored in the memory 92 that can be executed by the processor 91. When the processor 91 executes the computer program, the following steps can be implemented:

Obtaining a three-dimensional model of an operation area of a movable platform;
Control a motion trajectory of a virtual movable platform in the three-dimensional model according to a detected motion control operation;
Determine multiple target position points on the motion trajectory according to a detected position confirmation operation, where the multiple target position points are used to generate an operation path of the movable platform in the operation area.

In some exemplary embodiments, the motion control operation includes one or more of the following: a lateral control operation, a longitudinal control operation, an altitude control operation, and a yaw control operation of the virtual movable platform.

In some exemplary embodiments, the motion control operation is triggered by a joystick, and the motion control amount of the motion control operation is determined based on a detected shift amount of the joystick.

In some exemplary embodiments, the processor is also configured to: determine and store operation parameters corresponding to the target position points according to the detected operation parameter confirmation operation, where the operation parameters are used to indicate that the movable platform performs operations upon reaching the target position points.

In some exemplary embodiments, the movable platform carries a camera load, and the operation parameters include orientation parameters of the camera load in space. The orientation parameters are used to indicate that when the movable platform reaches the target position point, the camera load performs operations according to the orientation parameters.

In some exemplary embodiments, the processor is also configured to: determine operation results corresponding to the target position points, and adjust the target position points and/or the operation parameters corresponding to the target position points based on the operation results.

In some exemplary embodiments, the load on the movable platform includes a photographing device, and the operation results include a deviation between a captured image from the photographing device and a sample image.

In some exemplary embodiments, the processor is also used to: determine the observation angle of the virtual observation device carried on the virtual movable platform based on the attitude during the movement of the virtual movable platform, and project the three-dimensional model onto the observation angle to obtain an observation image that is displayed in real time on the interactive interface.

In some exemplary embodiments, the processor is configured to control the motion trajectory of a virtual movable platform in the three-dimensional model based on the detected motion control operation, specifically configured to:
based on the detected motion control operation, control the virtual movable platform to depart from a first position in the three-dimensional model and move toward other areas in the three-dimensional model;
the determination of multiple target position points on the motion trajectory based on the detected position confirmation operation, where the multiple target position points are used to generate the operation path of the movable platform in the operation area, includes:
based on the detected position confirmation operation, determine the current position of the virtual movable platform in the three-dimensional model as a second position, where the first position and the second position are used to generate the operation path of the movable platform in the operation area.

In some exemplary embodiments, the processor is further configured to, in response to an editing operation, perform any of the following operations:
delete the determined target position point;
adjust the position of the determined target position point;
insert a new target position point between any two adjacent target position points;
modify the operation parameters corresponding to the target position point.

In some exemplary embodiments, the processor is further configured to, in response to a movement operation, control the virtual movable platform to move from the current position to any determined target position point.

In some exemplary embodiments, the processor is further configured to: display on the interactive interface an identifier representing the orientation of a virtual observation device mounted on the virtual movable platform, and/or the scenery in the three-dimensional model around the target position point.

In some exemplary embodiments, the processor is further configured to: display on the interactive interface a view of the three-dimensional model observed by the virtual movable platform, and/or a view presenting the relative positional relationship between the virtual movable platform and the three-dimensional model.

In some exemplary embodiments, the processor is further configured to: display the three-dimensional model on the interactive interface, with the display view angle of the three-dimensional model on the interactive interface including multiple view angles;
where the view angle positions of any two view angles among the multiple view angles are different, and/or the directions from the view angles of any two view angles toward the virtual movable platform are different.

In some exemplary embodiments, the processor is further configured to: the position of the view angle of any of the view angles changes with the movement of the virtual movable platform, while the relative position between the view angle and the virtual movable platform remains fixed.

In some exemplary embodiments, the processor is further configured to: display safety prompt information on the interactive interface;
where the safety prompt information is generated based on one or more of the following:

the relative positional relationship between a position point on the motion trajectory and an envelope point of the three-dimensional model;
the motion attitude change of the virtual movable platform on the motion trajectory.

In some exemplary embodiments, the processor is further configured to: acquire a sample image containing a target object obtained from observing the three-dimensional model, where the sample image is used to instruct the movable platform to capture a real-world image containing the target object during the operation process along the operation path.

In some exemplary embodiments, when the processor is configured to acquire a sample image containing a target object obtained from observing the three-dimensional model, it is specifically configured to:
based on the attitude of the virtual movable platform during its motion, determine the observation view angle of the virtual observation device mounted on the virtual movable platform;
obtain an observation image obtained by projecting the three-dimensional model onto the observation view angle, and determine the sample image based on the observation image.

In some exemplary embodiments, determining the sample image based on the observation image includes any of the following methods: using the observation image as the sample image; or using the image area at the center of the observation image as the sample image; or using the image area selected by the user from the observation image as the sample image.

In some exemplary embodiments, the processor is further configured to: acquire a real-world image collected by the movable platform while operating along the operation path within the operation area;
extract an image area selected by the user from the real-world image as a sample image containing a target object, where the sample image is used to instruct the movable platform to capture a real-world image containing the target object during subsequent operations.

In some exemplary embodiments, the three-dimensional model is generated based on images of the operation area collected by controlling the movable platform.

In some exemplary embodiments, the multiple target position points used to generate the operation path of the movable platform in the operation area include:
determining a sorting of the target position points to connect the multiple target position points to generate the operation path in the operation area, where the sorting of the target position points differs from the order in which the target position points were confirmed.

In some exemplary embodiments, the processor is further configured to: determine multiple operation tasks of the virtual movable platform at the target position points based on an operation task confirmation operation;
instruct the movable platform to execute the multiple operation tasks at the target position points in a target operation order, where the target operation order differs from the order in which the multiple operation tasks were determined.

In some exemplary embodiments, the processor is further configured to: display the target position points on the interactive interface;
adjust the display effect of the target position points on the interactive interface based on the operation results corresponding to the target position points.

Additionally, some exemplary embodiments of the present disclosure further provide an operation planning device for a movable platform, the device including a processor, a memory, and a computer program stored in the memory executable by the processor, where when the processor executes the computer program, the following steps can be implemented:
obtain a three-dimensional model of the operation area of the movable platform;
control the virtual observation device to move in the virtual space where the three-dimensional model is located based on a motion control operation, and display the observation image of the three-dimensional model captured by the virtual observation device during the motion in real-time on a user interactive interface;
in response to a user's confirmation operation, determine a target geographic attitude corresponding to the attitude of the virtual observation device in the virtual space, where the target geographic attitude is used to instruct the movable platform to operate in the operation area.

Moreover, some exemplary embodiments of the present disclosure further provide an operation planning device for a movable platform, the device including a processor, a memory, and a computer program stored in the memory executable by the processor, where when the processor executes the computer program, the following steps can be implemented:
obtain an operation path planned in a three-dimensional model of an operation area, and operation parameters of path points on the operation path, where the operation path is generated based on the motion attitude of a virtual movable platform in the three-dimensional model and the observation image of the three-dimensional model by the virtual movable platform;
control the movable platform to move along the operation path within the operation area and perform operations based on the operation parameters of the path points, obtaining operation content;
obtain an operation result(s) from analyzing the operation content;
adjust the operation path and the operation parameters of the path points on the operation path based on the operation result(s);
control the movable platform to operate within the operation area based on the adjusted operation path and the adjusted operation parameters.

Correspondingly, some exemplary embodiments of the present disclosure further provide a computer storage medium, in which a program is stored, and when the program is executed by a processor, the method in any of the above embodiments is implemented.

Some exemplary embodiments of the present disclosure can take the form of a computer program product implemented on one or more storage media containing program code (including but not limited to magnetic disk storage, CD-ROM, optical storage, etc.). Computer-usable storage media include permanent and non-permanent, removable and non-removable media, which can implement information storage by any method or technology. Information can be computer-readable instructions, data structures, program modules, or other data. Examples of computer storage media include but are not limited to: Phase-Change Random Access Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory or other memory technologies, Compact Disc Read-Only Memory (CD-ROM), Digital Versatile Disc (DVD) or other optical storage, magnetic cassettes, magnetic tape, magnetic disk storage or other magnetic storage devices, or any other non-transmission medium that can be used to store information accessible by computing devices.

For the device embodiments, since they basically correspond to the method embodiments, relevant parts can be referred to in the description of the method embodiments. The device embodiments described above are merely illustrative. The units described as separate components may or may not be physically separate, and the components displayed as units may or may not be physical units, i.e., they may be located in one place or distributed across multiple network units. Some or all modules can be selected to implement the purpose of the scheme according to actual needs. Ordinary technicians in the field can understand and implement this without creative effort.

It should be noted that in this document, relationship terms such as “first” and “second” are only used to distinguish one entity or operation from another entity or operation, and do not necessarily require or imply any actual relationship or sequence between these entities or operations. The terms “comprise,” “contain,” or any other variations thereof are intended to cover non-exclusive inclusion, such that a process, method, article, or device that includes a series of elements not only includes those elements but also includes other elements not explicitly listed, or also includes elements inherent to such process, method, article, or device. Without further limitation, an element defined by the statement “comprising a/an . . . ” does not exclude the presence of additional identical elements in the process, method, article, or device that includes the said element.

The methods and devices provided by some exemplary embodiments of this disclosure have been described in detail above. Specific examples have been applied in this document to explain the principles and implementation methods of this disclosure. The explanation of the above embodiments is only used to help understand the method and core idea of this disclosure. At the same time, for a person of ordinary skill in the art, based on the idea of this disclosure, there will be changes in specific implementation methods and application ranges. In summary, the content of this disclosure should not be understood as a limitation of this disclosure.

What is claimed is:

1. An operation planning method for a movable platform, comprising:
obtaining a three-dimensional model of an operation area of the movable platform;
controlling a motion trajectory of a virtual movable platform in the three-dimensional model based on a detected motion control operation; and
determining a plurality of target position points on the motion trajectory based on a detected position confirmation operation, wherein the plurality of target position points are configured to generate an operation path of the movable platform in the operation area.

2. The method based on claim 1, wherein the motion control operation comprises at least one of a lateral control operation, a longitudinal control operation, an altitude control operation, or a yaw control operation of the virtual movable platform.

3. The method based on claim 1, further comprising:
determining and storing operation parameters corresponding to the target position points based on a detected operation parameter confirmation operation, wherein the operation parameters are configured to instruct the movable platform to perform operations upon reaching the target position points.

4. The method based on claim 3, wherein the movable platform is equipped with a camera, the operation parameters comprise an orientation parameter of the camera in space, and the orientation parameter is configured to instruct the camera to perform operations based on the orientation parameter when the movable platform reaches the target position points.

5. The method based on claim 1, further comprising:
determining, based on an attitude of the virtual movable platform, an observation view angle of a virtual observation device mounted on the virtual movable platform; and
displaying, on an interactive interface, an observation image obtained by projecting the three-dimensional model onto the observation view angle in real-time.

6. The method based on claim 1, wherein the controlling of the motion trajectory of the virtual movable platform in the three-dimensional model based on the detected motion control operation comprises:
controlling, based on the detected motion control operation, the virtual movable platform to depart from a first position in the three-dimensional model and move toward another area in the three-dimensional model; and
the determining of the plurality of target position points on the motion trajectory based on the detected position confirmation operation, wherein the plurality of target position points are configured to generate the operation path of the movable platform in the operation area comprises:
determining, based on the detected position confirmation operation, a current position of the virtual movable platform in the three-dimensional model as a second position, wherein the first position and the second position are configured to generate the operation path of the movable platform in the operation area.

7. The method based on claim 1, wherein in response to an editing operation, at least one of the following operations is implemented:
deleting the determined target position points;
adjusting positions of the determined target position points;
inserting a new target position point between any two adjacent target position points; or
modifying operation parameters corresponding to the target position points.

8. The method based on claim 1, further comprising:
in response to a moving operation, controlling the virtual movable platform to move from a current position to any determined target position point.

9. The method based on claim 1, further comprising:
displaying, on an interactive interface, at least one of an identifier representing orientation of a virtual observation device mounted on the virtual movable platform, or a scenery in the three-dimensional model surrounding the target position points.

10. The method based on claim 1, further comprising:
displaying, on an interactive interface, at least one of a view of the three-dimensional model observed from the virtual movable platform, or a view showing a relative positional relationship between the virtual movable platform and the three-dimensional model.

11. The method based on claim 1, further comprising:
displaying the three-dimensional model on an interactive interface, with a display view angle of the three-dimensional model on the interactive interface comprising a plurality of view angles, wherein
the plurality of view angles satisfy at least one of: view angle positions of any two view angles among the plurality of view angles are different, or directions from view angles of any two view angles toward the virtual movable platform are different.

12. The method based on claim 11, wherein:
a view angle position of a view angle changes with a movement of the virtual movable platform, and a relative position between the view angle and the virtual movable platform remains fixed.

13. The method based on claim 1, further comprising:
displaying safety prompt information on an interactive interface, wherein
the safety prompt information is generated based on at least one of:
a relative positional relationship between position points on the motion trajectory and envelope points of the three-dimensional model, or
a motion attitude change of the virtual movable platform on the motion trajectory.

14. The method based on claim 1, further comprising:
obtaining a sample image containing a target object by observing the three-dimensional model, wherein the sample image is configured to instruct the movable platform to capture a real-world image containing the target object during an operation along the operation path.

15. The method based on claim 14, wherein the obtaining of the sample image containing the target object by observing the three-dimensional model comprises:
determining, based on an attitude of the virtual movable platform, an observation view angle of a virtual observation device mounted on the virtual movable platform;
obtaining an observation image by projecting the three-dimensional model onto the observation view angle; and
determining the sample image based on the observation image.

16. The method based on claim 15, wherein the determining of the sample image based on the observation image comprises at least one of:
using the observation image as the sample image;
using an image area at a center position of the observation image as the sample image; or
using an image area selected by a user in the observation image as the sample image.

17. The method based on claim 1, further comprising:
obtaining a real-world image captured by the movable platform while operating along the operation path within the operation area;
extracting an image area selected by a user from the real-world image as a sample image containing a target object, wherein
the sample image is configured to instruct the movable platform to capture the real-world image containing the target object during a subsequent operation.

18. The method based on claim 1, wherein the plurality of target position points is configured to generate the operation path of the movable platform in the operation area comprises:
determining a sorting of the target position points to connect the plurality of target position points to generate the operation path in the operation area, wherein
the sorting of the target position points differs from an order for determining the target position points.

19. The method based on claim 1, further comprising:
determining, based on an operation task confirmation operation, a plurality of operation tasks of the virtual movable platform at the target position points; and
instructing the movable platform to execute the plurality of operation tasks at the target position points in a target operation sequence, wherein
the target operation sequence differs from an order for determining the operation tasks.

20. An operation planning device for a movable platform, wherein the device comprises a processor, a memory, and a computer program stored in the memory that can be executed by the processor, wherein the processor, when executing the computer program, implements the following steps:
obtaining a three-dimensional model of an operation area of the movable platform;
controlling a motion trajectory of a virtual movable platform in the three-dimensional model based on a detected motion control operation; and
determining a plurality of target position points on the motion trajectory based on a detected position confirmation operation, wherein the plurality of target position points are used to generate an operation path of the movable platform in the operation area.
